(19) United States
(12) Patent Application Publication
(10) Pub. No.: US 2026/0117957 A1
(43) Pub. Date: Apr. 30, 2026

(54) DISPLAY DEVICE HAVING A BACKGROUND ILLUMINATION AND MEANS OF TRANSPORTATION HAVING SUCH A DISPLAY DEVICE

(71) Applicant: Continental Automotive Technologies GmbH, Hannover (DE)

(72) Inventors: Manrico JOSEPH, Ober-Ramstadt (DE); Jose Juan CORONA ESTRADA, Aschaffenburg (DE)

(21) Appl. No.: 19/371,051

(22) Filed: Oct. 28, 2025

(30) Foreign Application Priority Data
Oct. 29, 2024 (DE) 10 2024 210 418.3

(51) Int. Cl. F21V 19/00; B60R 11/02; F21K 9/237; F21K 9/238; F21K 9/68

(52) U.S. Cl. CPC F21V 19/0035; B60R 11/0229; F21K 9/237; F21K 9/238; F21K 9/68

(57) ABSTRACT

A backlight for a display device and to a means of transport having such a display device. The backlight for the display panel has a reflector with a plurality of reflective cavities, and a circuit board with a plurality of light sources. The light sources are arranged in the respective cavities of the reflector, wherein the reflector has a fastening element.

### BACKGROUND OF THE INVENTION

### 1. Field of the Invention

The present disclosure relates to a display device having a display panel and a backlight for the display panel, and to a transport having such a display device. Such display devices are nowadays used in almost every transport, for example in a motor vehicle.

### 2. Description of Related Art

The number and area of display devices in transport are constantly increasing. Display devices can be found in the market for example as an instrument cluster for the driver, as a central display and also as a passenger display. Non-self-illuminating transmissive display devices require a backlight for image representation. The task of the backlight is to illuminate the display panel used as uniformly as possible over the entire active surface in order to produce a display that is as homogeneous as possible right down to the edge region.

Backlights for display devices are often based here on light guides into which the light from a plurality of light sources (light-emitting diodes, LEDs) is coupled. The light propagates in the light guide by total internal reflection and is coupled out again with the aid of microstructures on the light guide, so that a homogeneous light distribution is produced. This design allows compact and efficient illumination of display panels.

As an alternative to backlights that is based on light guides, so-called matrix backlights can be used.

Matrix backlights use a plurality of light sources arranged in a matrix to produce light. Here, the light sources are arranged on a circuit board which is mounted on a housing of the backlight. Matrix backlights typically use a metallic body and a plastic reflector. The housing of the backlight has the task of providing a structure and holding all the components of the backlight together in the mounted state, in order that the backlight can be mounted as a component in the housing of the display device. The reflector of the backlight has a special geometry and has a plurality of cavities that direct the light emitted from the light sources in the direction of a display panel. This requires a certain distance between the light sources and the display panel of the display device in order to homogenize the light. However, if the installation height of the display device has to be reduced, which is increasingly the case in automotive applications, the installation height of the backlight unit must also be reduced.

A person skilled in the art is familiar with display devices having a display panel and a backlight for the display panel in various embodiments. For example, US 2010/141867 A1 describes such a display device, wherein a display panel or the like is illuminated from the back. The device has a display panel and a backlight for the display panel. The backlight comprises a flat, light-emitting component comprising a plurality of light sources and a reflector having a plurality of reflective cavities arranged above the component. A light source is assigned to each of the cavities. The flat, light-emitting component serves as a support plate for the backlight.

As the size of the display devices increases, so does the size of the backlight. Such large backlights usually consist of a plurality of composite elements that are connected to one another. In addition to a housing for the display device, the backlight often also has a separate housing for receiving individual components. The disadvantage here is that the housing for the backlight causes additional costs in the production and assembly. Another disadvantage is that the installation height of the display device is increased on account of the additional housing for the backlight, making a flatter installation height more difficult. The display device or the backlight can therefore be used only to a limited extent in vehicles with a low installation height owing to its installation height due to the additional housing of the backlight.

### SUMMARY OF THE INVENTION

An object of the present invention is to provide an improved display device having a backlight and a transport having such a display device, wherein a very flat installation height of the backlight and of the display device is achieved and furthermore sufficient stability for the backlight and uniform illumination of the display device are ensured.

One aspect of the invention provides a display device having a display panel and a backlight for the display panel, wherein the backlight comprises a reflector with a plurality of reflective cavities, and a circuit board comprising a plurality of light sources, wherein the light sources are arranged in the respective cavities of the reflector, wherein the reflector has a fastening element.

In this case, the backlight is arranged between a front glass of the display device and the display panel arranged there below and a housing of the display device. The backlight has, inter alia, a circuit board with light sources arranged thereon and a reflector, wherein the reflector orients the light emerging from the light sources in the direction of the display panel, with the result that homogeneous illumination of the display panel is achieved. The reflector is mounted on a surface of the front glass by the fastener formed on the reflector and an additional connector, and is held there.

This has the advantage that the backlight can be mounted in a display device particularly quickly and easily by the fastening element formed on the reflector, and can be replaced again in the event of a defect, without complicated disassembly, e.g. by releasing a plurality of individual components. Due to the reflector with the fastening element, it does not slip, because the reflector and the fastening element are connected to one another. This means that there is no need for any subsequent alignment and adjustment of the reflector, whereby costs for time-consuming adjustment after installation of the reflector are saved.

According to one aspect of the invention, the reflector and the fastening element are formed in one piece.

One advantage is that the one-piece design of the reflector with the fastening element makes it possible to produce also elaborate geometries of the reflector with thin walls of particularly high quality, without the reflector losing stability due to an additional connection point between the reflector and the fastening element. No additional mounting elements, which are less mechanically stable are required. The reflector with the fastening element can be produced quickly and easily, for example in an injection molding process, whereby manufacturing costs for additional manufacturing methods and tools are saved. By virtue of the one-piece design, the number of components to be assembled and the assembly devices required for this purpose is moreover reduced, and the assembly process is simplified.

Furthermore, the reflector designed in one piece with the fastening element is particularly light, yet strong enough in comparison to other solutions to ensure sufficient stability, for example for accommodating a circuit board and a heat-conducting plate. As a result, there is no need for a further component, for example an additional housing for the backlight, which housing serves to accommodate the individual components and to ensure sufficient stability of the backlight in the mounted state.

A further advantage is that due to the combination of the two elements, reflector and mount, into a single element, the installation height of the reflector and thus the installation height of the backlight are reduced.

According to one aspect of the invention, the fastening element is connectable to a housing in a force- and/or material-fitting and/or form-fitting manner.

A force-fitting connection is to be understood as meaning a mechanical connection in which two or more components are held together by the action of forces. The typical applications of force-fitting connections, for connecting a housing to a fastening element of the reflector, include, for example, a screw connection. One advantage is that a screw connection can be produced particularly easily and quickly, and the components connected to one another can be released from one another again without being destroyed.

A material connection is to be understood as meaning a connection in which two or more components are held together by atomic or molecular forces. The typical applications of material-fitting connections, for connecting a housing to a fastening element of the reflector, include, for example, an adhesive connection or also laser welding. One advantage consists in that a material connection is established between the components to be connected, which connection is particularly robust and stable with respect to acting forces and also with regard to acting vibrations. This is a permanent connection. This has the advantage that no further connecting element or connector is required to connect the individual components.

In the case of a material connection, e.g. by laser welding, the housing of the display device or the reflector to be connected thereto or the fastening element of the reflector can consist, for example, of a laser-transparent material. In order to connect the housing and the fastening element in the laser welding process, it is necessary for one of the two components to be connected to be laser-transparent and for the other component to be connected to be laser-absorbing. A laser-transparent material has the advantage that laser welding creates a very precise, fast, flexible and clean connection with the highest quality standards.

A form-fitting connection is to be understood to mean a connection in which two or more components engage into one another or fit together on account of their geometrical shapes. The typical applications of form-fitting connections include for example a snap-action hook connection or a rivet connection. A form-fitting connection by a rivet is produced by a cold-beaten rivet, wherein the rivet is composed of a plastics material. The fastening element of the reflector can in this case e.g. have one or more rivets, wherein the fastening element and the rivet are formed in one piece and are produced from one material, preferably plastic. One advantage is that a form-fitting connection between the components to be connected, the fastening element and the housing can be established particularly easily and quickly. In addition, a form-fitting connection can be quickly released again in a simple manner, wherein the essential components remain undamaged and are reusable.

In addition to the connection techniques listed above for a force-fitting, form-fitting and material fitting connection of the housing to the mount of the reflector, other connecting techniques that are not listed here or a combination of connecting techniques are also possible.

According to one aspect of the invention, the reflector has a mount for holding the circuit board.

In this case, the circuit board is held by a mount formed on an underside of the reflector. Here, the mount can be, for example, a clip or also a plurality of clips arranged on the underside of the circuit board for receiving and holding the circuit board. The clip is in this case preferably manufactured and formed in one piece with the reflector. The reflector with the clip may in this case be made of a plastic, for example. One advantage is that the one-piece reflector with the clip can be produced inexpensively in an injection molding process.

In an aspect of the invention, the circuit board is adhesively bonded, screwed or riveted onto the underside of the reflector. For example, the circuit board can be glued to the underside of the reflector with double-sided adhesive tape and connected to it. Depending on what is required for the specific project and the application of the backlight, the circuit board can also be screwed or riveted onto the underside of the reflector.

One advantage is that the circuit board being mounted directly on the underside of the reflector and being held by the mount achieves increased mechanical stability. The circuit board and the reflector, which rest flat on one another and are connected to one another, mutually stabilize herein.

A further advantage consists in that a further component, e.g. an additional housing for the backlight, which serves to receive and stabilize the components to be connected, can be dispensed with, whereby a flatter installation height of the backlight is made possible. Moreover, the components to be connected can be assembled and disassembled quickly and easily.

According to one aspect of the invention, the circuit board has a heat-conducting plate.

In the mounted state, the backlight consists of a circuit board, which is arranged above the heat-conducting plate and has the light sources arranged thereon, and a reflector which is arranged above the circuit board and the light sources. In order to ensure a longevity of the light sources and of the display device, the heat generated by the light sources is dissipated from each individual light source by the heat-conducting plate. The dissipated heat is dissipated for example via the rear side of the heat-conducting plate by heat radiation. In addition, the heat-conducting plate ensures further stability of the backlight, in particular for the reflector.

According to one aspect of the invention, a holding-down for illumination foils is provided.

The holding-down is a frame for holding and positioning the illumination foils, which are arranged and mounted above the reflector. This allows the backlight to be pre-assembled with all components and to be inserted into the display device in one piece, whereby further time-consuming assembly steps are dispensed with. In this way, there is no need for any adjustment of the individual components during the mounting in the display device. The same applies to disassembly and replacement, e.g. of a defective backlight.

A display device according to one aspect of the invention is preferably used in a transport in the automotive sector. The transport may be, for example, a motor vehicle, a passenger motor vehicle or a truck, but alternatively also an aircraft, a rail vehicle, or a watercraft.

Further features of the present invention become apparent from the following description and the appended claims in connection with the figures. Advantageous refinements of the invention are also apparent from the features of the following description and the figures.

For better understanding of the principles of the present invention, embodiments of the invention are explained in more detail below with reference to the figures. The same reference numerals are used in the figures for identical or functionally identical elements and are not necessarily described again for each figure. It is to be understood that the invention is not restricted to the illustrated embodiments and that the features described may also be combined or modified without departing from the scope of protection of the invention as defined in the appended claims.

### BRIEF DESCRIPTION OF THE DRAWINGS

In the drawings, in a schematic, diagrammatic representation:

FIG. 1 is a sectional side view through a display device having a reflector of the backlight;

FIG. 2 is a sectional side view through a display device having a reflector of the backlight;

FIG. 3 is a sectional side view through a display device having a reflector of the backlight;

FIG. 4 is a sectional side view through a display device having a reflector of the backlight; and

FIG. 5 is a transport that uses a display device.

### DETAILED DESCRIPTION OF THE PRESENTLY PREFERRED EMBODIMENTS

The present description illustrates the principles of the present disclosure. It therefore goes without saying that the person skilled in the art will be able to develop various arrangements which, though not expressly described or shown herein, embody the principles of the disclosure.

All examples and conditional wordings provided herein are for educational purposes to assist the reader to understand the principles of the disclosure and the concepts that have been contributed by the inventor to the advancement of the field, and are to be construed as being without limitation to such specifically stated examples and conditions.

In addition, all statements contained herein regarding principles, aspects and embodiments of the disclosure, as well as specific examples thereof, comprise both structural and functional equivalents thereof. Moreover, it is intended that such equivalents comprise both currently known equivalents as well as equivalents developed in the future, i.e. all developed elements which, regardless of their structure, perform the same function.

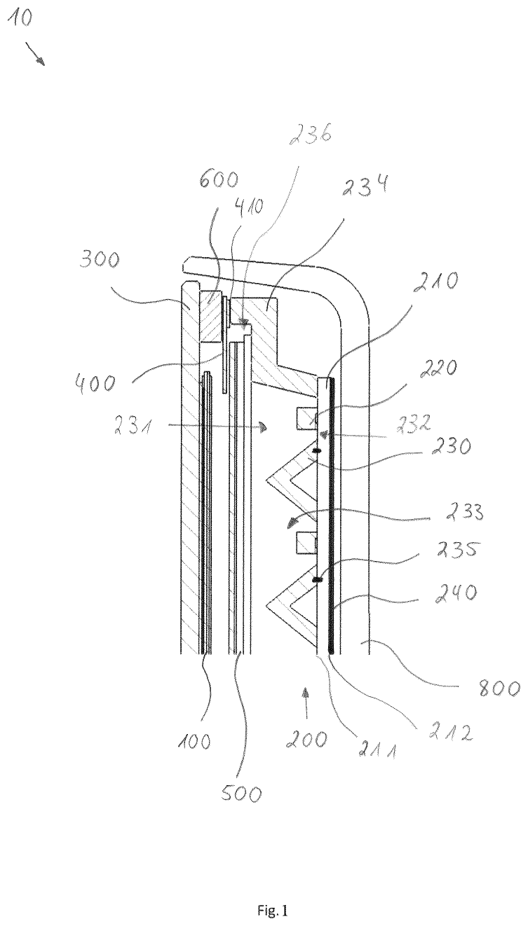

FIG. 1 schematically shows a sectional side view through a display device 10. FIG. 1 shows a detail view of a reflector 230 with a fastening element 234 of the backlight 200 of the display device 10.

The display device 10 has a display panel 100, which is adhesively bonded to a front glass 300 (also referred to as cover glass). The front glass 300 closes off a housing 800 of the display device 10 from the environment. The front glass 300 is adhesively bonded to the housing 800. The backlight 200 arranged in the display device 10 is thus enveloped and protected.

The backlight 200 for backlighting the display panel 100 comprises a plurality of components which are arranged one above the other and which are connected to one another in the assembled state. The individual components of the backlight 200, arranged one above the other and connected to one another, are pre-assembled as an assembly before they are then inserted into the housing 800 of the display device 10 and closed by the front glass 300 with the display panel 100 mounted thereon.

The assembly of the backlight 200 can also be directly connected to the front glass 300 and the display panel 100 mounted thereon before it is then inserted into the housing 800 of the display device 10.

The backlight comprises a heat-conducting plate 240 which is arranged and mounted on an underside 212 of the circuit board (PCB) 210. The heat-conducting plate 240 is adhesively bonded to the underside of the circuit board 212. The circuit board 210 serves as a support element for the heat-conducting plate 240. A plurality of light sources 220, typically light-emitting diodes (LEDs), are arranged on a upper side 211 of the circuit board 210. The light sources 220 are arranged in a matrix structure. Furthermore, the reflector 230, which has a plurality of cavities 233, is arranged and mounted on the upper side of the circuit board 211. In this case, the cavities 233 are arranged in a matrix structure. Each of the cavities 233 of the reflector 230 receives at least one light source 220 in the mounted state with the circuit board 210 and encloses its laterally. The individual light sources 220 are thus spatially separated from one another. The reflector 230 has a mount 235 on the underside 232, as a result of which the circuit board 210 is connected to the reflector 230. The reflector 230 serves here as a support element for the circuit board 210 and the heat-conducting plate 240 mounted on the circuit board.

As shown, the reflector 230 has a fastening element 234 arranged on the side of the reflector, wherein the reflector 230 can have a plurality of fastening elements 234 that are not shown here. The individual fastening elements 234 are in this case arranged on two opposite sides on the reflector in the direction of the housing 800 of the display device 10. In an alternative embodiment that is not shown, a plurality of fastening elements 234 can also be arranged all around, depending on the design of the housing 800, on the reflector 230, opposite or in an offset manner.

According to one aspect of the invention, the fastening element 234 of the reflector 230 is located in the edge region of the circuit board 210 running around the region in which the cavities 233 of the reflector 230 are located. In this case, the fastening element 234 preferably protrudes beyond the surface defined by the circuit board 210.

The fastening element 234, which is formed on the upper side of the reflector 231 and is formed in one piece with it, has a step 236 with the display panel 100 in the direction of the front glass 300, which carries illumination foils 500. The illumination foils 500 are a stack of optical foils. The individual foils of the optical foil stack have the task of scattering, collecting or diverting the light of the reflector 230 in such a way that the requirements for the light distribution of the backlight 200 for homogeneous backlight of the display panel 100 are met. Typical foils for light manipulation are brightness enhancement films (BEF) and light control films (LCF).

In the mounted state with the backlight 200, the illumination foils 500 are held in their position by a hold down 400. The hold down 400, which is in the form of a frame here, is in this case connected to the fastening element 234 of the reflector 230 by a connector 410, for example an adhesive bond.

The front glass 300 with the display panel 100 is in turn connected to the hold down 400 and to the backlight 200 by a connector 600, for example an adhesive bond.

In the mounted state, a gap exists between the housing 800 and the backlight 200, as a result of which better heat distribution in the display device 10 is achieved.

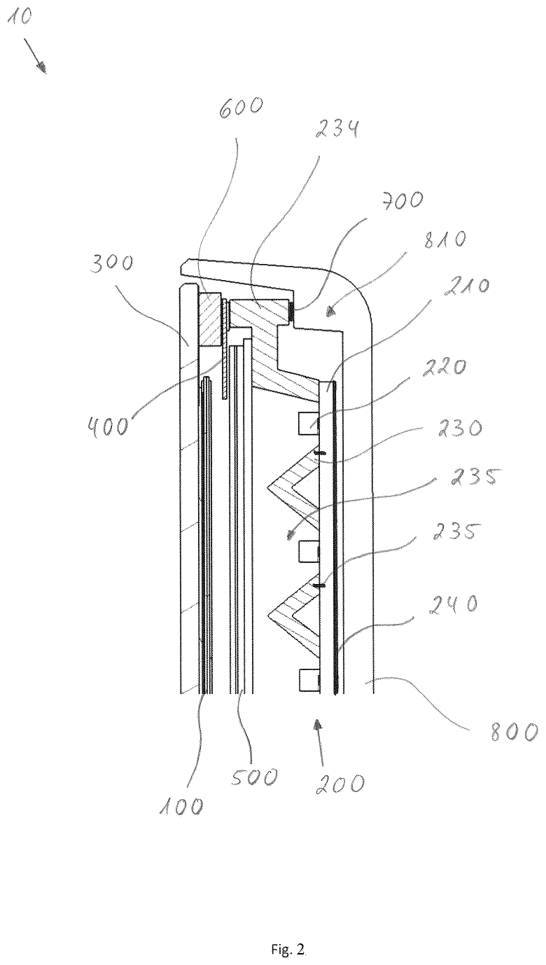

FIG. 2 schematically shows a sectional side view through a display device 10. FIG. 2 shows a detail view of a reflector 230 with a fastening element 234 of the backlight 200 of the display device 10.

A display device 10 is illustrated, which has a display panel 100 that is adhesively bonded to a front glass 300. The front glass 300 closes off a housing 800 of the display device 10 from the environment. A backlight 200 mounted in the display device 10 is thus enclosed and protected.

This second aspect corresponds mostly to FIG. 1. However, the fastening element 234 of the reflector 230 is designed such that the fastening element 234 has a further connector 700 and is directly connected to the housing 800 of the display device 10. For this purpose, the housing 800 has a step 810 on which the fastening element 234 rests in the assembled state. The fastening element 234 is fixedly connected to the step 810 of the housing 800 by a connector 700, for example an adhesive bond.

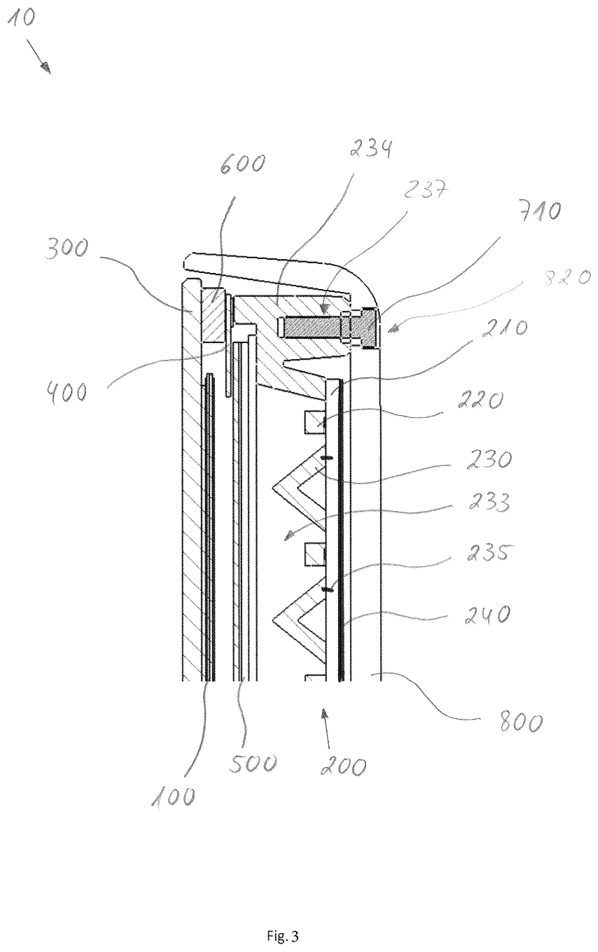

FIG. 3 schematically shows a sectional side view through a display device 10. FIG. 3 shows a detail view of a reflector 230 with a fastening element 234 of the backlight 200 of the display device 10.

A display device 10 is illustrated, which has a display panel 100 that is adhesively bonded to a front glass 300. The front glass 300 closes off a housing 800 of the display device 10 from the environment. A backlight 200 mounted in the display device 10 is thus enclosed and protected.

This third embodiment corresponds mostly to FIG. 1. However, the fastening element 234 of the reflector 230 is designed such that the fastening element 234 is directly connected to the housing 800 of the display device 10. For this purpose, the fastening element 234 has a thicker wall thickness as shown in FIG. 1. A recess 237, preferably as a blind hole, is formed in the fastening element 234. Here, the recess 237 may again have an internal thread (not illustrated).

A recess 820 is formed in the housing 800. By a connector 710, for example a screw, which is inserted into the recess 820, the housing 800 is fixedly connected to the fastening element 234. In the assembled state, the fastening element 234 rests flat on the housing 800.

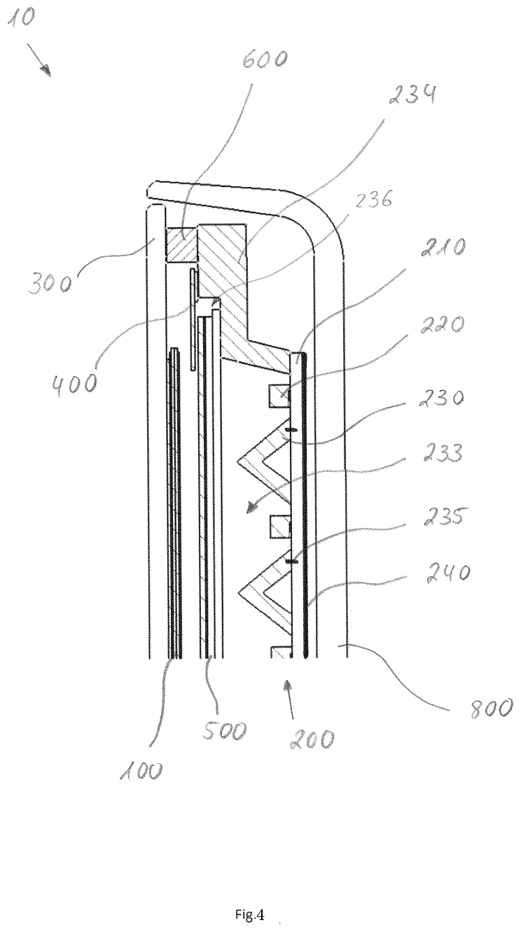

FIG. 4 schematically shows a sectional side view through a display device 10. FIG. 4 shows a detail view of a reflector 230 with a fastening element 234 of the backlight 200 of the display device 10.

A display device 10 is illustrated, which has a display panel 100 that is adhesively bonded to a front glass 300. The front glass 300 closes off a housing 800 of the display device 10 from the environment. A backlight 200 mounted in the display device 10 is thus enclosed and protected.

This fourth aspect corresponds mostly to FIG. 1. However, the fastening element 234 of the reflector 230 is designed such that it has a larger surface on which a hold down 400 and a connector 600 are arranged next to one another in the direction of the front glass 300 with the display panel 100, and are not stacked one above the other as in FIG. 1. This permits a small structural height.

The hold down 400 is in this case connected to the fastening element 234 of the reflector 230 by adhesive bonding and holds illumination foils 500 in a step 236 so as to prevent them from slipping in their position.

The front glass 300 with the display panel 100 is connected directly to the fastening element 234 of the reflector 230 by a connector 600, preferably by an adhesive bond. This has the advantage that in the case of a replacement, e.g. of the front glass 300 with the display panel 100, only one connecting point 600 has to be detached, without further connecting points or components of the display device 10 having to be damaged or readjusted.

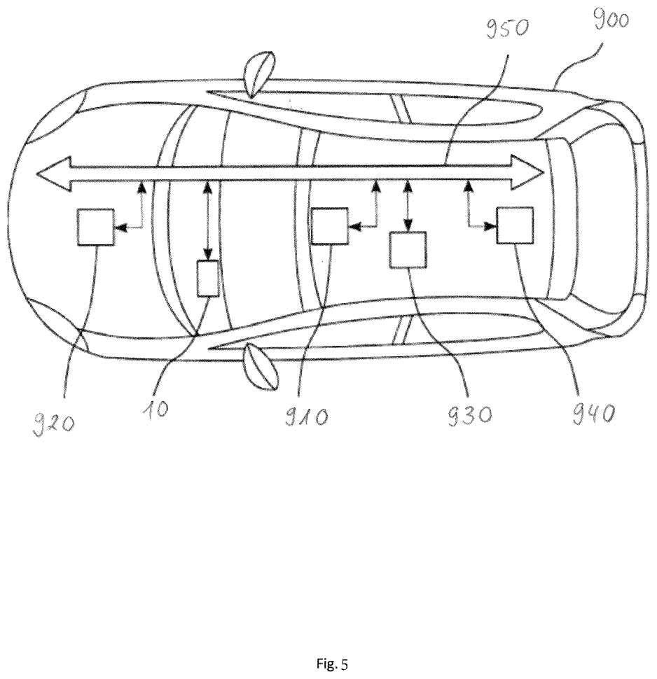

FIG. 5 shows schematically a transport 900 that uses a display device 10. In this example, the transport 900 is a motor vehicle. The motor vehicle has a display device 10, which is arranged in a dashboard. A sensor system 910 can be used to capture data pertaining to the vehicle surroundings. The sensor system 910 can comprise, in particular, surroundings recognition sensors, for example ultrasound sensors, laser scanners, radar sensors, lidar sensors or cameras. The information captured by the sensor system 910 can be used to generate contents to be displayed for the display device 10. Further component parts of the motor vehicle in this example are a navigation system 920, by which positional information can be provided, and also a data transmission unit 930. By the data transmission unit 930, for example a connection to a back-end can be set up, for example to obtain updated software for components of the motor vehicle. A memory 940 is available for storing data. Data is exchanged between the various components of the motor vehicle via a network 950.

Overall, the exemplary embodiment shows how the invention can easily provide an improved display device with a backlight and a transport with such a display device, wherein a flat installation height of the backlight is achieved with uniform illumination of the display device.

Thus while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A display device comprising:
a display panel; and
a backlight for the display panel, comprising:
a reflector having a plurality of reflective cavities and a fastening element; and
a circuit board which has a plurality of light sources,
wherein the plurality of light sources are each arranged in respective cavities of the reflector.

2. The display device according to claim 1, wherein the reflector and the fastening element are formed in one piece.

3. The display device according to claim 1, wherein the fastening element is connectable in a force- and/or material- and/or form-fitting manner to a housing.

4. The display device according to claim 1, wherein the reflector has a mount for holding the circuit board.

5. The display device according to claim 1, wherein the circuit board has a heat-conducting plate.

6. The display device according to claim 1, further comprising a holding-down for illumination foils.

7. A transport comprising:
a display device comprising:
a display panel; and
a backlight for the display panel, comprising:
a reflector having a plurality of reflective cavities and a fastening element; and
a circuit board which has a plurality of light sources,
wherein the plurality of light sources are each arranged in respective cavities of the reflector.

8. The display device according to claim 2, wherein the fastening element is connectable in a force- and/or material- and/or form-fitting manner to a housing.
